(19) United States
(12) Patent Application Publication
(10) Pub. No.: US 2022/0198870 A1
(43) Pub. Date: Jun. 23, 2022

(54) DEVICE AND METHOD FOR TREATING PRODUCTS

(71) Applicant: ENGROTEC SYSTEMS GMBH, Neusitz (DE)

(72) Inventor: Werner HUPRICH, Ohrenbach (DE)

(21) Appl. No.: 17/603,258

(22) PCT Filed: Dec. 17, 2019
(86) PCT No.: PCT/DE2019/101102

§ 371 Date: Oct. 12, 2021

(30) Foreign Application Priority Data
Dec. 17, 2018 (DE) 10 2018 009 765.0

(51) Int. Cl. G07F 17/00; A21B 1/48; G07F 11/26; A21B 3/00

(52) U.S. Cl. CPC G07F 17/0078; A21B 3/00; G07F 11/26; A21B 1/48

(57) ABSTRACT

Device (10) for treating products (100), in particular bakery products, comprising: at least one treating unit (40), comprising at least one storage belt (41) and arranged to process the products (100); at least one dispensing unit (50), comprising at least one storage belt (51) and arranged to dispense the products (100); at least one operating device (20), arranged to transport the products (100); wherein the operating device (20) comprises at least one operating belt (21) and at least one coupling device (30); wherein the operating belt (21) is arranged to store the products (100); wherein the coupling device (30) is arranged to couple the operating belt (21) with a storage belt (41, 51) in order to exchange the products (100) with the coupled storage belt (41, 51), and wherein the operating device (20) comprises at least one operating belt (21) and at least one coupling device (30).

wherein the coupling device (30) comprises at least one drive unit (23) which is arranged to drive at least one storage belt (41, 51) coupled to the operating device (20).

The invention relates to a device, a method and an operating device for treating products, in particular for processing and dispensing bakery products. Furthermore, the present invention relates to the use of an operating device for treating products.

In the course of digitalization, common tasks that were previously performed by a human can be done by machines. This is especially true for identically repeating processes. Especially with regard to the treating of products, especially consumer products and food, such an exchange will be possible. For example, automatic baking machines, such as those used in particular by discounters, are enjoying increased popularity in competition with traditional bakeries. However, the full automation of such a system, without significant use of labor, brings with it various problems, such as feasibility, increased costs and/or government requirements.

The object of the present invention is therefore defined by providing an improved device and method for treating products.

According to one aspect, the device for treating products, in particular bakery products, comprises at least one treating unit comprising at least one storage belt and arranged to handle the products, at least one dispensing unit comprising at least one storage belt and arranged to dispense the products, at least one operating device arranged to transport the products. The operating device comprises at least one operating belt and at least one coupling device. The operating belt is arranged to store the products. The coupling device is arranged to couple the operating belt with a storage belt, in order to exchange the products with the coupled storage belt. The coupling device comprises at least one drive unit arranged to drive at least one storage belt coupled to the operating device.

By exchanging products in the sense of the disclosure it is to be understood that products are transferred from the operating belt to the storage belt or vice versa.

Preferably, the operating belt and the storage belt are each characterized by movable belts which are movable about deflection rollers at the ends of the respective belts.

Preferably, the belt of the operating belt has recesses. Air can circulate through these recesses, which can lead, for example, to faster cooling of hot products, in particular bakery products.

Further preferably, the belt of the operating belt comprises metal, fabric, plastic and/or combinations thereof, more preferably, the belt of the operating belt comprises metal, plastic and/or combinations thereof, more preferably, the belt of the operating belt comprises metal. By using metal, the belt of the operating belt is particularly robust and heat resistant.

Preferably, the belt of the operating belt is designed as a rod braided belt.

Preferably, the belt of the operating belt can be removed without tools. This enables the belts to be replaced quickly in the event of a defect or for cleaning.

Belts that are not operating belts are referred to as storage belts. Storage belts in a dispensing unit can also be referred to as output belts, storage belts in a treating unit can also be referred to as processing belts. Storage belts are characterized by the fact that they can be driven by an operating device. Storage belts are also referred to as belts to be coupled for the purposes of the invention.

The belts of the storage belts are preferably made of fabric, plastic, fabric coated with plastic and/or combinations thereof.

Preferably, the belts of the storage belts can be removed without tools. This enables the belts to be replaced quickly in the event of a defect or for cleaning.

According to one embodiment, the belts of the storage belts do not have recesses.

According to a further embodiment, the belts of the storage belts have recesses. Air can circulate through these recesses, which can lead, for example, to faster cooling of hot products, in particular baked products. Further preferably the belts of the storage belts comprise metal, fabric, plastic and/or combinations thereof, more preferably the belts of the storage belts comprise metal, plastic and/or combinations thereof, more preferably the belts of the storage belts comprise metal. By using metal, the belts of the storage belts are particularly robust and heat resistant.

According to a preferred embodiment, at least a part of the belts of the storage belts comprises recesses. According to this embodiment, at least a part of the belts of the storage belts comprises metal, fabric, plastic and/or combinations thereof, preferably at least a part of the belts of the storage belts comprises metal, plastic and/or combinations thereof, more preferably at least a part of the belts of the storage belts comprises metal. The belts of the storage belts without recesses are configured as described further above.

In particular, the belts of the storage belts of the at least one treating unit comprise recesses, provided that heating of the products, in particular bakery products, is carried out in the treating unit. In this embodiment, the belts of the storage belts of the treating unit comprise metal, fabric, plastic and/or combinations thereof, preferably the belts of the storage belts comprise metal, plastic and/or combinations thereof, more preferably the belts of the storage belts comprise metal.

According to a preferred embodiment, the operating belt is formed in several parts, preferably in two parts.

Preferably, the storage belt is also formed in several parts, preferably in two parts.

A more precise treating of the products can be ensured by a multi-part design of the operating belt and/or the storage belt.

Preferably, the operating device comprises at least one sensor, preferably two sensors, which detects and monitors the loading of the operating belt. This at least one sensor, preferably two sensors, is an acoustic, magnetic, inductive, capacitive, resistive, mechanical, electrical, thermoelectric, piezoelectric, electronic and/or optical sensor. Preferably, the sensor is an optical sensor, preferably a camera, a photoelectric sensor and/or combinations thereof, which the products being exchanged with the operating belt must pass.

In another preferred embodiment, the operating device comprises a weight sensor that detects and monitors the load on the operating belt. This sensor is preferably an acoustic, magnetic, inductive, capacitive, resistive, mechanical, electrical, thermoelectric, piezoelectric, electronic, electromechanical and/or optical sensor, more preferably an electromechanical and/or optical sensor, even more preferably an electromechanical sensor.

Examples of sensors that may find application in the device according to the invention and in particular in the operating device include ultrasonic sensors, acceleration sensors, pressure sensors, force sensors, inclinometers, displacement sensors, level sensors, flow meters and weight sensors.

Mechanical sensors can be pressure gauges, strain levers, spring scales, lever scales and/or thermometers. A thermoelectric sensor may be in the form of a thermocouple. Resistive sensors may be strain gauges, hot-wire and/or semiconductor strain gauges and/or, for example, Pt100 sensors. A piezoelectric sensor can be an acceleration sensor. Capacitive sensors can be pressure sensors. Inductive sensors may be inclinometers, force sensors and/or displacement sensors. Optical sensors may be photoelectric sensors, cameras, CCD sensors, and/or photocells. Acoustic sensors may be in the form of level sensors, double sheet control, and/or ultrasonic flow meters. Examples of magnetic sensors include Hall sensors and reed contacts.

According to a further preferred embodiment, the operating device comprises at least one light barrier and a weight sensor for detecting and monitoring the loading of the operating belt.

The operating device also comprises a driving unit. The driving unit of the operating device is arranged to move the operating device from a first position to a second position different from the first position. For example, the driving unit moves the operating device to a storage or processing device. The driving unit comprises a position sensor. The position sensor determines the position of the operating device. By being able to determine the position accurately, the operating device can be aligned with other devices, that is, there is an alignment of the operating device with the respective device comprising storage belts.

Through the coupling device, a movement of the operating belt can be transmitted to the storage belt. In this way, products can be exchanged between the operating belt and the storage belt without the respective units comprising storage belts including an active component for exchanging products.

Preferably, the operating device comprises at least two coupling devices. Further preferably, the operating device comprises at least four coupling devices.

Preferably, the coupling devices are arranged laterally to the belt, in case of a plurality of operating belts, laterally to the belts. The coupling devices do not contact the belt of the operating belt.

The coupling device, preferably the at least two coupling devices, is arranged to align the operating belt and the storage belt to be coupled with respect to each other, to lock a force-transmitting element of the coupling device to a force-absorbing element of the storage belt to be coupled, and to lock the position of the operating belt to the storage belt.

According to a preferred embodiment, in the coupled state the belt of the operating belt and the belt of a coupled storage belt are without contact. Direct contacting of the belts of the operating belt and the storage belt is avoided by coupling by means of the coupling device, preferably the at least two coupling devices. By avoiding direct contact between the belts, contamination is prevented from being transferred from one belt to the other. Also, the transfer of heat from one belt to the other belt is minimized since there is no direct contact.

Preferably, the coupling device does not contact the belt of the operating belt or the belt of a storage belt in the coupled state. Further preferably the at least one coupling device, preferably the at least two coupling devices, are arranged laterally adjacent to the belt of the operating belt.

The storage belts have elements which cooperate with the coupling device of the operating belt. Thus, the storage belts have elements for force absorption, so-called force-absorbing elements, whereby the force is transmitted from the operating belt to the storage belt.

Furthermore, the storage belt comprises an element which is necessary for the interlocking between the operating belt and the storage belt. This is a connecting element which interacts in a form-fitting and/or force-fitting manner with the connecting element, also referred to as the locking element, of the coupling device.

The interaction of the aforementioned elements brings about the three functions of alignment, locking and interlocking between the operating and storage belts.

The coupling device can be designed in one piece or in several pieces.

Likewise, the force-absorbing element and the connecting element of the storage belt can be formed in one piece or also in several pieces. Preferably, the force-absorbing element and the connecting element are formed in two parts.

Preferably, the coupling device comprises an element for force transmission, also referred to as force-transmitting element, from the operating belt to the storage belt. Preferably, the coupling device is performed at least in two parts, wherein there is a force-transmitting element and a locking element, also referred to as a connecting element, of the coupling device.

According to a preferred embodiment, the coupling device is arranged to couple the operating belt to the storage belt mechanically, preferably by means of an intermediate element, preferably an intermediate wheel.

The coupling device preferably comprises an intermediate element, preferably an intermediate wheel for reversing the rotational movement of the operating belt, since in the case of a direct mechanical coupling of the operating belt to the storage belt, the operating belt and the storage belt would be driven in opposite directions, so that no products can be exchanged between the operating belt and the storage belt.

According to a further preferred embodiment, the coupling device comprises an intermediate element, preferably an intermediate wheel, for force transmission, an alignment element which aligns the intermediate element, preferably intermediate wheel, to the force-absorbing element of the storage belt such that a force transmission can take place. Furthermore, the coupling device comprises a connecting element, also referred to as a locking element, which connects the operating belt to the storage belt and thus allows a directional force transmission. Preferably the intermediate element, preferably the intermediate wheel, the alignment element and the connecting element are driven by only one drive unit, preferably a motor.

Preferably, the operating device comprises at least two coupling devices arranged parallel to each other, which detachably connect the operating belt to the storage belt, enable a directional force transmission and allow an alignment. While the operating device is connected to the storage belt via the coupling device, it is not possible to change the position of the operating device.

According to a further preferred embodiment, the coupling is contactless. In this embodiment, the coupling device preferably comprises a magnetic force transmission device for transmitting rotational forces from the operating belt to the storage belt in order to couple the operating belt to the storage belt without contact.

According to a preferred embodiment, the coupling device comprises at least one drive unit arranged to drive at least one storage belt coupled to the operating device. Preferably, the entire coupling device is driven by only one drive unit.

According to a further preferred embodiment, the at least one operating belt and the coupling device are driven by only one drive unit, preferably a motor.

Preferably, the drive unit comprises a motor for driving the operating belt.

Preferably, the drive unit is arranged to drive individual sections of the operating belt independently of each other.

Preferably, each coupling device comprises at least one sensor, also referred to as a coupling sensor, which detects and monitors the coupling state. This at least one coupling sensor is an acoustic, magnetic, inductive, capacitive, resistive, mechanical, electrical, thermoelectric, piezoelectric, electronic and/or optical sensor.

According to another preferred embodiment, the coupling device comprises at least two sensors.

According to a preferred embodiment, the operating device comprises a supporting device arranged to support and move the operating belt horizontally and/or vertically.

All degrees of freedom of the operating device have a zero position.

Preferably, the operating device comprises a storage frame and/or a storage spar on which the supporting device is mounted. Further preferably, the storage frame and/or the storage spar comprises a guide rail on which the supporting device can be moved horizontally and/or vertically.

Due to the vertical movement of the operating belt, the operating belt can be aligned vertically to the storage belt.

For determining the vertical position of the operating belt, the operating device comprises a sensor. Preferably, this is an acoustic, magnetic, inductive, capacitive, resistive, mechanical, electrical, thermoelectric, piezoelectric, optical and/or electronic sensor, more preferably a mechanical, electrical and/or electronic sensor. For position determination, the operating belt may assume a zero position in the vertical plane.

Due to the horizontal movement of the operating belt, the operating belt can perform a so-called initial stroke, whereby the operating belt is moved in a horizontal plane towards the storage belt.

For determining the horizontal position of the operating belt, the operating device comprises a sensor. Preferably, this is an acoustic, magnetic, inductive, capacitive, resistive, mechanical, electrical, thermoelectric, piezoelectric, electrical and/or electronic sensor, more preferably an electrical and/or electronic sensor. For position determination, the operating belt may assume a zero position in a horizontal plane.

Preferably, the supporting device comprises one drive unit, preferably one motor, per processing belt to ensure the movability of the operating belt in the supporting device. Provided that the supporting device comprises a plurality, preferably two operating belts, the supporting device also comprises a plurality of drive units, preferably two drive units, preferably two motors.

According to a preferred embodiment, the supporting device is arranged to swivel the operating belt against the horizontal plane. The maximum tilt angle, α, is 15° from the horizontal plane; this means the operating belt has a tilt angle of +15° to −15° in both directions. Preferably, the tilt angle is 8° or less. The tilt angle can be adjusted continuously. For determining the tilt angle of the operating belt, the operating device comprises a sensor. Preferably, this is a mechanical, inductive, electrical and/or electronic sensor. For position determination, the operating belt can assume a zero position.

Coupling between the operating belt and a tilted storage belt is thus possible. The operating belt can be aligned with the storage belt by pivoting to the same angle as the inclined storage belt before the actual coupling process.

According to a preferred embodiment, the operating device comprises a storage frame on which the supporting device is mounted.

The storage frame provides structural integrity to the operating device and defines the range of motion of the operating belt.

According to a preferred embodiment, the operating device comprises a cleaning device arranged to clean a coupled storage belt. Preferably, the cleaning device comprises at least one mechanical cleaning element, at least one suction device and/or at least one disinfection device. Preferably, the mechanical cleaning device is a brush. Preferably, the suction device is a vacuum cleaner or a wet-dry vacuum cleaner.

In a preferred embodiment, the operating device comprises a brush, a disinfecting device and a suction device.

Preferably, the suction device is designed to pick up solid particles as well as liquids, it is then designed as a so-called wet-dry suction device. Preferably, the cleaning device is arranged such that falling particles can be picked up by the suction device during product transfer to or from the operating device. The suction device can also pick up applied liquids, such as disinfectant solution.

Further preferably, the cleaning device is arranged such that, in the coupled state, belts which are not operating belts can be cleaned mechanically, for example by means of a brush and/or by means of applying cleaning and/or disinfecting solutions.

Preferably, the cleaning device is arranged below the operating belt.

Preferably, the cleaning device comprises at least one sensor, the so-called cleaning sensor. This cleaning sensor is an acoustic, magnetic, inductive, capacitive, resistive, mechanical, electrical, thermoelectric, piezoelectric, electronic and/or optical sensor. The cleaning sensor detects and monitors the cleaning process.

In a further preferred embodiment, the operating device comprises a suction device. This suction device is set up in such a way that it can suck up particles from the floor. This enables regular cleaning of the floor in the working area of the operating device. Preferably, the suction device is designed in such a way that it can pick up solid particles as well as liquids, it is then designed as a so-called wet-dry suction device.

According to a further embodiment, the cleaning device is preferably integrated in an operating belt which does not usually store products.

According to a preferred embodiment, the operating device is designed as a driverless transport system, AGV. Preferably, a movement of the operating device is determined by a rail system.

Preferably, the operating device can move inside or outside the device.

In case of a movement of the operating device on a rail system, the rail system may run on the floor and/or on the ceiling. Alternatively, a guide of the operating device is also fixed at a predetermined height above the floor, in particular in a range from 0 cm to 50 cm, preferably from 15 cm to 50 cm and more preferably from 30 cm to 50 cm above the floor. In this way, the floor under the operating device can be cleaned without having to move the operating device.

In the aforementioned manner, the entire active technology for transporting and exchanging the products between different units of the device is integrated in the operating device. The respective units, such as filling unit or treating unit, can thus be comparatively less complex units which are already available on the market as standard units and can be procured and/or exchanged at low cost.

Preferably, the device comprises several operating devices. If the operating devices should fail for any reason for a short period of time, the device will still function without an operating device, but will require manual labor.

Due to the operating belt, the operating device can also handle usual trays, baking paper, separating foils, silicone supports on which the products are located instead of, in addition to or supplementary to the products. For example, the products can be moved on these additional supports to optimize cleanliness.

Preferably, the products comprise food, preferably canned food, bakery products, cured meats, fruits and/or vegetables, further preferably refrigerated, frozen, pre-baked and/or non-pre-baked food, in particular bakery products. Bakery products in raw form preferably comprise refrigerated, frozen and/or pre-baked bakery products.

According to a preferred embodiment, the device for treating products, is a device for treating food, preferably for treating canned food, bakery products, sausages, meat, fruit and/or vegetables, more preferably for treating bakery products.

Preferably, the device also comprises a cooling device, in particular a deep-freeze storage unit, which is also equipped with storage belts. Preferably, the cooling device comprises doors. Preferably, the degree of opening of the doors is detected and monitored by means of at least one sensor. This sensor is preferably an acoustic, magnetic, inductive, capacitive, resistive, mechanical, electrical, thermoelectric, piezoelectric, electronic and/or optical sensor.

Preferably, the treating unit comprises doors. The degree of opening of the doors is preferably detected and monitored by means of at least one sensor. This sensor is preferably an acoustic, magnetic, inductive, capacitive, resistive, mechanical, electrical, thermoelectric, piezoelectric, electronic and/or optical sensor.

According to a preferred embodiment, the treating unit is a device for heating. Preferably the treating unit is an oven, more preferably a vacuum oven.

According to a preferred embodiment, the device comprises at least one storage unit comprising at least one storage belt and arranged to store the products.

According to a preferred embodiment, the device comprises at least one filling unit comprising at least one storage belt and arranged to fill the device with products.

According to a preferred embodiment, the device comprises a control device arranged to control the operating device in a self-learning manner.

Preferably, the control device is arranged to control each unit of the device in a self-learning manner.

Preferably, the control device is in the form of a processor.

Preferably, the control device comprises a machine-learning device which preferably provides a control unit of the control device with parameters for the control. The parameters of the machine-learning device are adapted in a self-learning manner based on learning data and training data, preferably based on information about the filling of the device and the output of the device. Preferably, the information about the output of the device comprises sensor data from a weight sensor on a storage belt of the dispensing unit.

Preferably, the storage belts of the dispensing unit are detachably connected to the dispensing unit.

This ensures that they can be easily exchanged to adapt them to different output products or to clean them.

Due to the self-learning control, the scrap of products produced by the device can be reduced. Likewise, energy can be saved, since for example the number of machining cycles can be reduced, but also the control of the machining unit or also of a cooling unit can be adapted.

In the previously described manner, an almost fully automatic device for processing and dispensing products can be provided, which saves costs, in particular personnel costs. In addition, a more hygienic work is possible, as less personnel comes into contact with the products.

According to one aspect, the method of treating products comprises the steps of:
Processing of the products by a treating unit comprising at least one storage belt;
Coupling an operating belt of an operating device to a storage belt by a coupling device of the operating device;
exchanging products between the operating belt and the storage belt coupled to the operating belt; and
Dispensing of the products by a dispensing unit comprising at least one storage belt.

The step of coupling the operating belt comprises various individual steps. First, the operating device is positioned in front of the unit, in the present case the treating unit, with which an interaction is to take place. This positioning is achieved by a drive unit, whereby the positioning is detected and monitored by a sensor, the so-called position sensor.

In the next step, the coupling device is aligned with the corresponding storage belt. Here, the force-transmitting element is aligned with the force-absorbing element of the storage belt. The force-transmitting element and the force-absorbing element are locked so that a force transmission is possible. At the same time, locking takes place so that the operating belt is fixed in a position relative to the storage belt and the force-transmitting element can perform a directed force transmission onto the force-absorbing element.

Preferably, the interlocking is a positive or non-positive connection.

The fixation has the effect that the forces are transmitted directionally from the operating device to the storage belt during the force transmission. During force transmission, forces act that could cause incorrect positioning of the coupling device if it were not fixed.

The individual functions may be performed by different elements and devices of the coupling device. However, it is also possible for a single element and/or device to perform several functions of the coupling device.

The force transmission takes place without direct contact between the belts. This avoids that the belts contaminate each other, and it is also possible that both the belt of the operating belt and the belt of the storage belt can be made of different materials that do not allow a sufficient transmission of force. Furthermore, it is avoided that abrasion is generated by the contacting of the belts which could contaminate the products.

Likewise, this type of coupling makes it possible to compensate for temperature differences between the operating device, i.e. the belt of the operating belt, and the belt of the storage belt and still ensure a reliable coupling. Also, variances between the coupling device and the locking element as well as the force-absorbing element can be better compensated.

Further preferably, the coupling device is driven by only one drive unit. This prevents the coupling process from being out of sync and prevents coupling failures.

Preferably, the operating device is moved to a zero position during commissioning. In this case, the operating device and the operating belt are moved to a zero position.

Another aspect of the invention relates to an operating device according to the invention for treating products, wherein the operating device comprises at least one operating belt and at least one coupling device;

whereby the operating belt is set up to store products;
wherein the coupling device is arranged to couple the operating belt to a storage belt in order to exchange products with the coupled storage belt;
wherein the coupling device comprises at least one drive unit which is arranged to drive at least one storage belt coupled to the operating device.

The details given above for the device for treating products according to the invention and the method according to the invention also apply accordingly to the operating device. The features of the operating device according to the invention can thus be selected from the above statements.

According to a preferred embodiment, in the coupled state, the belt of the operating belt and the belt of a coupled storage belt are without contact; and/or

the coupling device (30) is arranged to couple the operating belt (21) to the storage belt (41, 51) mechanically, preferably with the aid of an intermediate element, preferably an intermediate wheel (31), or contactlessly; and/or
the coupling device comprises only one drive unit; and/or
the operating belt (21) is made of several parts, preferably two parts; and/or
the operating device (20) has a supporting device (22) which is arranged to support the operating belt (21) and to move it horizontally and/or vertically.

Another aspect relates to the use of an operating device according to the invention for treating products, preferably for treating food products, more preferably for treating bakery products, sausages, meat, fruit and/or vegetables.

The statements made above about the device for treating products according to the invention, the method according to the invention and the operating device according to the invention also apply accordingly to the use of the operating device.

Further advantages of the invention will be apparent from the following description of preferred embodiments, which, however, are not to be understood as limiting in any way.

All embodiments of the invention may be combined within the scope of the invention.

An example embodiment is described in more detail below with reference to the accompanying drawings. Therein shows:

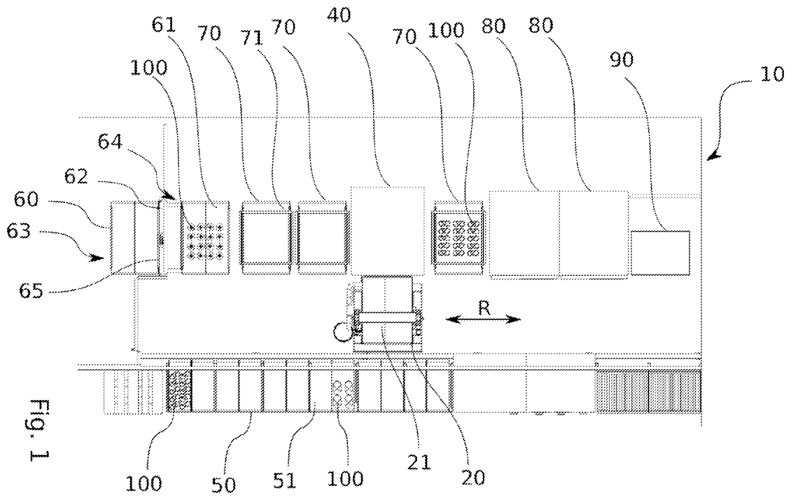

FIG. 1 Schematic top view of a device for treating products;

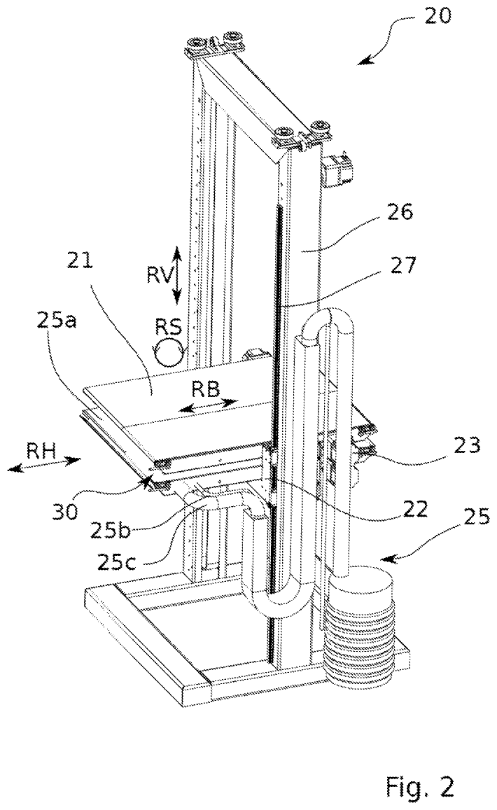

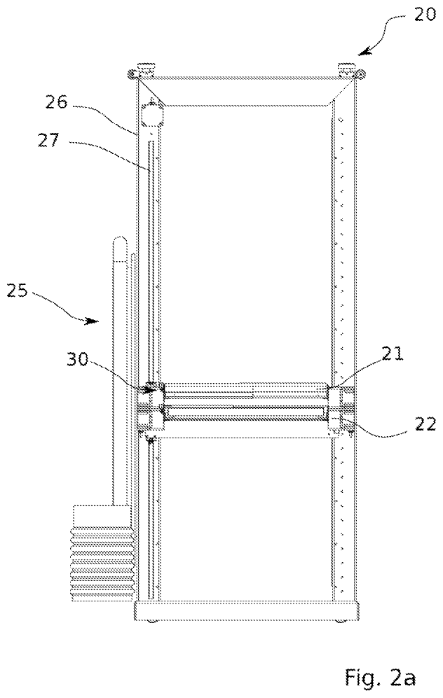

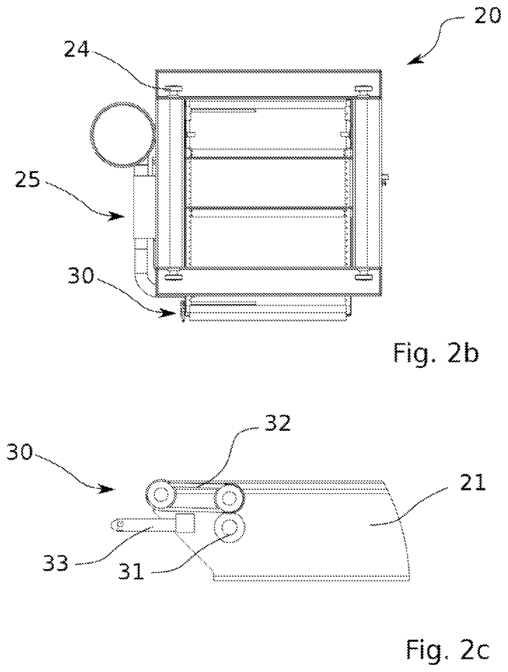

FIG. 2 a perspective view of an operating device according to a first embodiment;

FIG. 2a a front view of the operating device according to the first embodiment;

FIG. 2b a bottom view of the operating device according to the first embodiment;

FIG. 2c an enlarged view of a coupling device of the operating device according to the first embodiment;

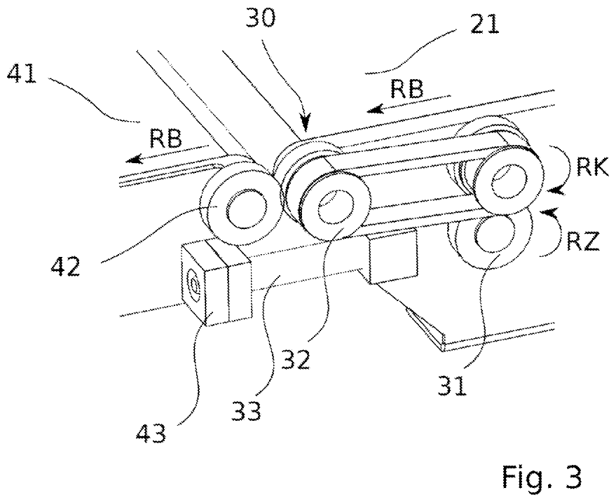

FIG. 3 a perspective view of a coupled coupling device of the operating device according to the first embodiment;

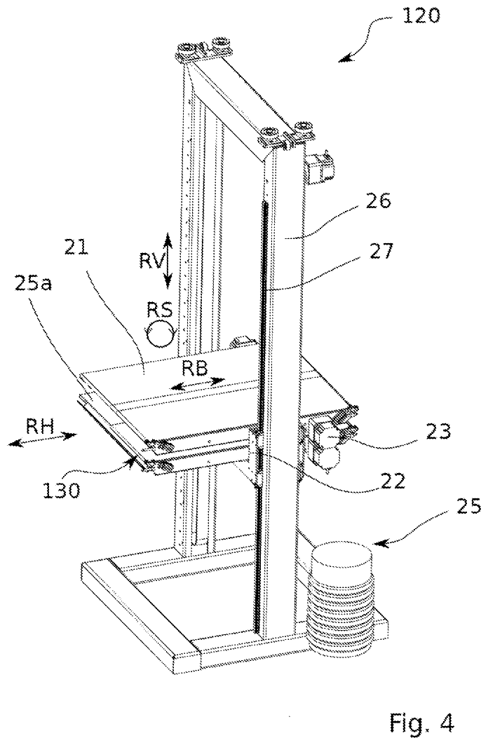

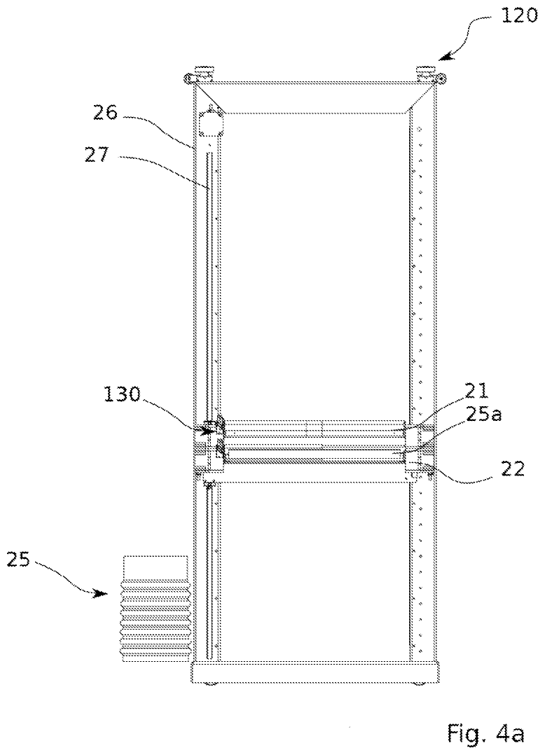

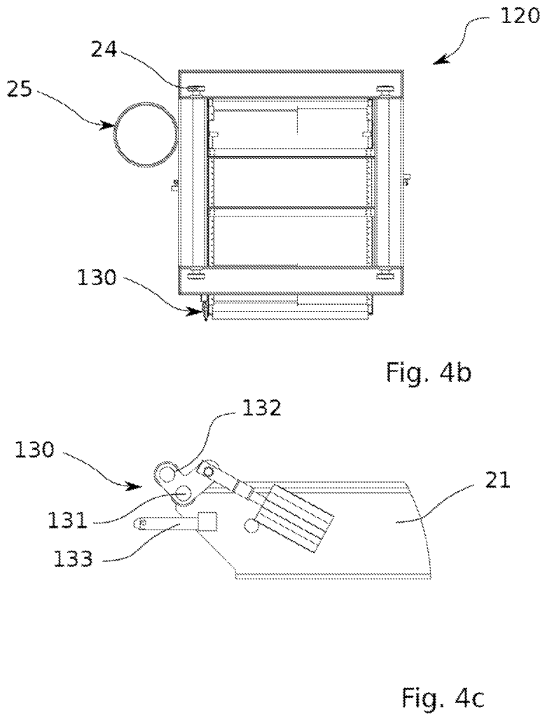

FIG. 4 a perspective view of an operating device according to a second embodiment;

FIG. 4a a front view of the operating device according to the second embodiment;

FIG. 4b a bottom view of the operating device according to the second embodiment;

FIG. 4c an enlarged view of a coupling device of the operating device according to the second embodiment; and

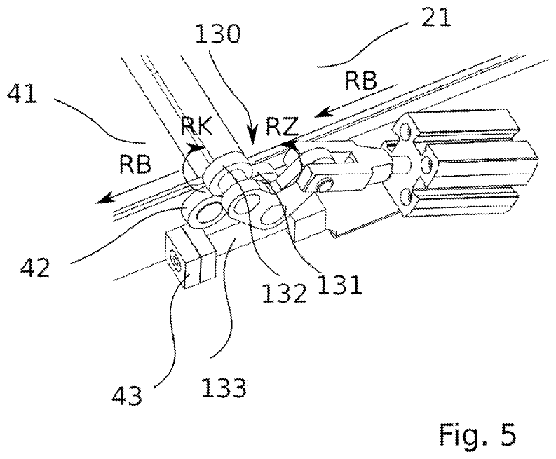

FIG. 5 a perspective view of a coupled coupling device of the operating device according to the second embodiment.

Identical reference signs, as used in various embodiments, denote identical elements of each embodiment.

FIG. 1 shows a schematic top view of a device 10 for treating products. In this embodiment example, the device is designed as an automatic baking machine 10 which treats bakery products 100 as products. The automatic baking machine comprises an operating device 20, a treating unit in the form of a baking oven 40, a plurality of dispensing units 50, a filling unit 60 and a plurality of storage units 70. In addition, the automatic baking machine 10 comprises a deep-freeze storage unit 80 and a reject receiving unit 90. The automatic baking machine 10, in particular the operating device 20, is controlled by a control device (not shown).

The individual units 40, 50, 60, 70, 80 preferably each comprise a plurality of storage belts 41, 51, 61, 71, 81 which are further preferably arranged horizontally one above the other.

The automatic baking machine 10 can be filled via the filling unit 60. Typically, this task is performed by an operator. The filling unit 60 comprises at least one storage belt 61, on which the bakery products 100 are to be placed in raw form. In order that the operator knows which type of bakery product 100 is to be placed in the filling unit 60, the filling unit 60 comprises a display device 62, in particular a monitor, which indicates to the operator which type of bakery product 100 is to be placed on the storage belt 61 of the filling unit 60. Preferably, the filling unit 60 comprises a filling area 63 and a storage area 64. For filling the filling unit 60, the storage belt 61 is arranged in the filling area 63. The filling area 63 is accessible on an exterior of the automatic baking machine 10 such that the operator can place the bakery products 100 on the storage belt 61 disposed therein. After the storage belt 61 has been filled, the storage belt 61 moves from the filling area 63 to the storage area 64, which is arranged inside the automatic baking machine 10 and is not accessible to the operator. The operator thus has access only to the filling area 63 of the filling unit 60 during the smooth operation of the automatic baking machine.

In order for the operator to know exactly where to place the bakery products 100 on the storage belt 61, the filling unit 60 preferably comprises a projector 65 which projectingly marks the locations on the storage belt 61 where the operator is to place the bakery products 100.

For an efficient filling process, the operator preferably receives a signal to fill the automatic baking machine 10. The control device of the automatic baking machine 10 indicates to the operator, via the display device 62, the type of bakery product 100 to be filled. The operator fetches the corresponding bakery products, which are still in raw form, from a product store. Via an operator impulse, in particular an input unit, such as a button, on the automatic baking machine 10, a release for filling is effected. Preferably, this is confirmed by a signal tone. The operator can now move the storage belt 61 from the storage area 64 from a retracted position into the filling area 63 to an extended position. When the storage belt 61 has reached the extended position, a placement grid is projected onto the storage belt 61 via the projector 65 or displayed on the display device 62. After the operator has filled the storage belt 61 and thus the filling unit 60, the filling is acknowledged, in particular by scanning a product code from a container of the bakery products 100 from the product storage. Only when the acknowledgement has been made, the filling operation can be completed, otherwise the control device will refuse to fill.

After filling, the bakery products 100 are in raw form on the storage belt 61 of the filling unit 60, which is in the retracted position. The control device then directs the operating device 20 to pick up the bakery products 100 to convey them to the baking oven 40.

The operating device 20 has an operating belt 21 onto which the bakery products 100 are to be transferred from the storage belt 61 of the filling unit 60. The operating device 20 has a driving unit 24, which is designed, for example, as a chassis with a plurality of tires, in order to allow the operating device 20 to move between the individual units, such as between the filling unit 60, the storage unit 70, the baking oven 40 and/or the dispensing unit 50. In this regard, the operating device 20 may be configured as a driverless transport system, AGV, which allows maximum mobility of the operating device 20. Alternatively, a fixed mobility is also possible by means of a rail system. To pick up the bakery products 100 from the storage belt 61 of the filling unit 60, the operating device 20 moves to the filling unit 60 and positions itself in front of the filling unit 60 in such a way that the operating belt 21 of the operating device 20 is arranged horizontally in front of the storage belt 61 of the filling unit 60.

The operating belt 21 is supported in the operating device 20 by a supporting device 22. The supporting device 22 moves the operating belt 21 in the vertical direction RV until the operating belt 21 is horizontally level with the storage belt 61. In order to be able to exchange products 100 between the storage belt 61 of the filling unit 60 and the operating belt 21 of the operating device 20, the storage belt 61 of the filling unit 60 and the operating belt 21 of the operating device 20 must be coupled to each other. This coupling may be mechanical or contactless. The only decisive factor is that both the storage belt 61 of the filling unit 60 and the operating belt 21 of the operating device 20 rotate in the same direction at an identical speed. In this way, the products 100 can be interchanged with each other. As can be seen in FIG. 1, both the operating belt 21 and the storage belt 61 of the filling unit 60 are formed in two parts. Each of the two parts of the storage belt 61 of the filling unit 60 and the operating belt 21 can perform rotation separately from each other.

For coupling the storage belt 61 of the filling unit 60 and the operating belt 21, the operating device 20, in particular the supporting device 22, performs a so-called initial stroke, in which the operating belt 21 is moved in the horizontal direction RH towards the storage belt 61 of the filling unit 60 until the operating belt 21 is in a coupling position. In the coupling position, there is only a very small gap between the storage belt 61 of the filling unit 60 and the operating belt 21, and a coupling device 30 of the operating device 20 couples the operating belt 21 to the storage belt 61 of the filling unit 60. When the operating belt 21 is coupled to the storage belt 61 of the filling unit 60, a drive unit 23 provided for this purpose, preferably in the form of a motor, drives the operating belt 21 in such a way that it rotates away from the filling unit 60. By coupling the operating belt 21 to the storage belt 61 of the filling unit 60, the movement of the operating belt 21 is transmitted to the storage belt 61 of the filling unit 60 in such a way that the latter rotates in the same direction, that is to say in the direction of the operating device 20. In this way, the products 100 are transferred from the storage belt 61 of the filling unit 60 to the operating belt 21. A detailed embodiment of the coupling is described in the figures described below.

In the same manner, the operating device can move between each unit, filling unit 60, storage unit 70, oven 40, dispensing unit 50 and/or deep-freeze storage unit 80, and pick up or dispense products 100.

After receiving the products 100 to be processed from the filling unit 60, the operating device 20 transports the products 100 either to the storage unit 70 or to the baking oven 40. Via the respective storage belts 41, 71, the operating device 20 can either remove the products 100 or fill the respective units with products. The respective action is controlled by the control device. After baking the products 100 in the baking oven 40, the finished products 100 are picked up by the operating device 20 and transported to the dispensing unit 50.

The dispensing unit 50 includes one or more bulk or piece dispensers on an exterior of the automatic baking machine 10. Through these outputs, customers can remove the finished products 100 from the automatic baking machine 10. The bulk or piece goods dispensers can have various designs, such as flaps, each for only one product or an entire level, or individual removal options, which preferably enable 24-hour operation in a vandalism-proof manner.

Typically, the dispensing unit 50 has a storage belt 51 which is arranged at an angle, since this way a better presentation and selection possibility for the customers is possible. In this case, in order to couple the operating belt 21, the supporting device 22 pivots the operating belt 21 after it has been aligned vertically with respect to the storage belt 51 of the dispensing unit 50 in addition to the horizontal displacement of the initial stroke also in accordance with the storage belt 51 of the dispensing unit 51, and thus inclines it in order to reach the coupling position. The coupling method here is basically the same as the coupling method described between the operating belt 21 and the respective storage belt 41, 51, 61, 71, 81.

Additionally, by the described function of the control device 20, rejected products 100 can be transported from the dispensing unit 50 to the reject receiving unit 90 where they can be collected for further recycling. Products 100 are preferably marked as reject by the control device and disposed of from the dispensing unit 50 when the products 100 have spent a predetermined reject time in the dispensing unit 50 and could not be sold. The dwell time that individual products or batches of products have spent in the dispensing unit 50 is monitored by the control device. The control device compares this time to a product dependent reject time. Typically, the reject time is three to four hours, but may be as low as two hours for example for fine products such as croissants. If the dwell time of a product 100 exceeds the corresponding reject time, the respective product is marked as a reject and transported by the control device 20 to the reject receiving unit 90 and dispensed.

The control device monitors and controls the entire automatic baking machine 10. The control device is provided with real-time data via various sensors, such as weight sensors on the operating belt 21 and/or the storage belts 41, 51, 61, 71, 81, as well as information from the user or the individual units 40, 50, 60, 70, 80. In addition, the control device preferably comprises a machine-learning device by which the control device is optimized. In this way, the control device can control the filling of the automatic baking machine 10 in such a way that as little waste as possible is produced. According to the purchasing behaviour of the customers, i.e. according to the produced rejects of individual types of products 100, the machine-learning device adjusts the control of the control device in such a way that according to the type of product 100, the time, the location and/or the date, the filling of the automatic baking machine 10 is adjusted. For example, croissants sell particularly sluggishly at later times. Accordingly, the control device will bake and refill fewer croissants in the afternoon than in the morning to avoid waste.

FIGS. 2, 2a and 2b show an operating device 20 according to a first embodiment. The operating device 20 comprises an operating belt 21, a supporting device 22, a drive unit 23, a driving unit 24, a cleaning device 25, a storage frame 26, a guide rail 27 and a coupling device 30. In this embodiment, the storage frame 26 is designed as a closed frame. However, other embodiments are also conceivable. For example, the storage frame 26 may also be configured as a single spar as long as it has sufficient integrity to support the supporting device 22 and the operating belt 21 supported therein. The storage frame 26 includes the guide rail 27, which is arranged in a vertical direction on the storage frame 26. The supporting device 22 is arranged on the guide rail 27, which in turn receives the operating belt 21.

The supporting device 22 is vertically movable along the guide rail 27. In this way, the supporting device 22 can move the operating belt 21 supported therein in the vertical direction RV. This is required to align the operating belt 21 horizontally with a storage belt 41, 51, 61, 71, 81. In addition, the supporting device 22 allows the operating belt 21 to be moved in the horizontal direction RH. This function is referred to as the initial stroke. Furthermore, the operating belt 21 can be tilted about the supporting device 22 in a tilting direction RS. This function is particularly important for the filling and removal of products 100 from tilted storage belts 51, as in the case of the dispensing unit 50. Especially in the case of long bakery products, such as baguettes, an inclined coupling of the operating belt 21 with the storage belt 51 is important.

The operating belt 21 can be driven by the drive unit 23 in an operating belt direction RB. Depending on whether products are to be loaded onto the operating belt 21 or removed from the operating belt 21, the operating belt 21 can be driven in one of the two operating belt directions RB. As shown in FIGS. 2, 2a and 2b, the operating belt 21 is formed in two parts, so that the respective half of the operating belt 21 can be driven independently of the other half of the operating belt 21.

The cleaning device 25 comprises a suction device, in this case a vacuum cleaner 25c, and/or a disinfection device 25b arranged laterally on the storage frame 26 and guided to one end of a cleaning operating belt 25a formed similarly to the operating belt 25. Additionally, the cleaning operating belt 25a has access points for the disinfecting device 25b and the vacuum cleaner 25c at one end. A collection device for collecting product debris may also be provided at a leading edge of the cleaning operating belt 25a. By coupling the cleaning operating belt 25a to a storage belt 41, 51, 61, 71, 81, the respective storage belt 41, 51, 61, 71, 81 can be cleaned over its entire storage surface. Preferably, the control device controls the cleaning device 25 in such a way that cleaning is carried out at a time when there is a particularly low demand for products, in particular at night.

FIG. 2c shows an enlargement of the coupling device 30. The coupling device 30 is provided at one end of the operating belt 21 and comprises an intermediate wheel 31, a contact wheel 32 and a connecting element 33. Direct contact of the operating belt 21 with a storage belt 41, 51, 61, 71, 81 would not serve the desired purpose of having the operating belt 21 and the storage belt 41, 51, 61, 71, 81 rotate in the same belt direction RB to exchange products 100. Therefore, the coupling device 30 comprises an intermediate wheel 31 which is connected to the operating belt 21 and rotates in a direction opposite to the belt direction RB due to direct contact. The intermediate wheel 31 drives the contact wheel 32 in precisely this direction opposite to the belt direction RB. When the contact wheel 32 now establishes contact with the storage belt 41, 51, 61, 71, 81, the movement of the contact wheel 32 is transmitted to the storage belt 41, 51, 61, 71, 81, which thus moves in the belt direction RB and thus in the opposite direction to the contact wheel 32. The connecting element 33 supports the coupling of the operating belt 21 to the storage belt 41, 51, 61, 71, 81 and serves primarily as an orientation aid and/or spacing aid.

FIG. 3 shows a coupling of the operating belt 21 with a storage belt 41 of a baking oven 40, which is used here only as an example. In this example, the operating belt 21 moves in the operating direction RB toward the storage belt 41 to transfer products 100 from the operating belt 21 to the storage belt 41. If the operating belt 21 were directly connected to the storage belt 41 to transmit the movement of the operating belt 21 directly to the storage belt 41, the storage belt 41 would move in a direction opposite to the operating direction RB. Thus, an exchange of products 100 between the operating belt 21 and the storage belt 41 would not be possible. Therefore, the intermediate wheel 31 is provided which rotates in accordance with the operating belt 21 in the intermediate wheel direction RZ. The movement of the intermediate wheel 31 in the intermediate wheel direction RZ is transmitted to the contact wheel 32. Here, the described direction reversal takes place so that the contact wheel 32 rotates in a contact wheel direction RK. The contact wheel 32 now contacts another contact wheel 42 of the storage belt 41, whereby the movement of the contact wheel 32 of the coupling device 30 is transmitted to the contact wheel 42 of the storage belt 41. Again, a reversal of direction takes place so that the storage belt 41 now moves in the operating direction RB and products 100 can be transferred from the operating belt 21 to the storage belt 41. In addition, for coupling, the connecting element 33 of the coupling, device 30 is inserted into a connecting element 43 of the storage belt 41. In this way, a minimum distance between the storage belt 41 and the operating belt 21 and their alignment with each other can be ensured. As shown in FIG. 3, the operating belt (21) and the storage belt (41) are aligned with each other by the coupling by means of the coupling device (30) so that the force transmitting element, contact wheel (32), and the force-absorbing element, contact wheel (42), are engaged with each other and locked. The contact wheels may also be configured as gears, not shown here. By engaging connecting element (33) in connecting element (43), the coupling device is locked and, in addition to fixing the position of the operating belt (21) with respect to the storage belt (41), directional transmission of force from the operating belt (21) to the storage belt (41) is ensured. It is also shown that the operating belt (21) and the storage belt (41) do not contact each other.

FIGS. 4, 4a and 4b show an operating device 120 according to a second embodiment. The operating device 120 of the second embodiment differs from the operating device 20 of the first embodiment in particular by a coupling unit 130 of the second embodiment which is different from the coupling device 30 of the first embodiment.

FIG. 4c shows an enlargement of the coupling device 130. The coupling device 130 is provided at one end of the operating belt 21 and includes an intermediate wheel 131, a contact wheel 132, and a connecting element 133. The coupling device 130 is arranged laterally to the belt of the operating belt 21 and does not contact the belt of the operating belt 21.

Directly contacting the operating belt 21 with a storage belt 41, 51, 61, 71, 81 would not achieve the desired purpose of having the operating belt 21 and the storage belt 41, 51, 61, 71, 81 rotate in the same belt direction RB to exchange products 100. Therefore, the coupling device 130 comprises the intermediate wheel 131 which is connected to the operating belt 21 and rotates opposite to the belt direction RB due to the direct contact. The intermediate wheel 131 drives the contact wheel 132 in this very direction opposite to the belt direction RB. When the contact wheel 132 now establishes contact with the storage belt 41, 51, 61, 71, 81, the movement of the contact wheel 132 is transmitted to the storage belt 41, 51, 61, 71, 81, which thus moves in the belt direction RB and thus in the opposite direction to the contact wheel 132. The coupling element 133 supports the coupling of the operating belt 21 with the storage belt 41, 51, 61, 71, 81 and serves primarily as an orientation aid. In contrast to the coupling device 30 of the first embodiment, the contact wheel 132 is rotatably mounted around the intermediate wheel 131. For coupling the operating belt 21 with the storage belt 41, 51, 61, 71, 81, the contact wheel 132, which is otherwise mounted horizontally relative to the operating belt 21, is rotated about the intermediate wheel 131 in such a way that the contact wheel 132 contacts a contact wheel of the corresponding storage belt 41, 51, 61, 71, 81.

FIG. 5 shows a coupling of the operating belt 21 with a storage belt 41 of a baking oven 40, which is used here only as an example. In this example, the operating belt 21 moves in the operating direction RB toward the storage belt 41 to transfer products 100 from the operating belt 21 to the storage belt 41. If the operating belt 21 were directly connected to the storage belt 41 to transmit the movement of the operating belt 21 directly to the storage belt 41, the storage belt 41 would move in a direction opposite to the operating direction RB. Thus, an exchange of products 100 between the operating belt 21 and the storage belt 41 would not be possible. Therefore, the intermediate wheel 131 is provided which rotates in accordance with the operating belt 21 in the intermediate wheel direction RZ. The movement of the intermediate wheel 131 in the intermediate wheel direction RZ is transmitted to the contact wheel 132 via. Here, the described direction reversal takes place so that the contact wheel 132 rotates in a contact wheel direction RK. The contact wheel 132 now contacts another contact wheel 42 of the storage belt 41, whereby the movement of the contact wheel 132 of the coupling device 30 is transmitted to the contact wheel 42 of the storage belt 41. Again, a reversal of direction takes place so that the storage belt 41 now moves in the operating direction RB and products 100 can be transferred from the operating belt 21 to the storage belt 41. In addition, for coupling, the connecting element 133 of the coupling device 130 is inserted into a connecting element 43 of the storage belt 41. In this way, a minimum distance between the storage belt 41 and the operating belt 21 and their alignment with respect to each other can be ensured.

List of reference signs

| | |
|---|---|
| 10 | Device |
| 20 | Operating device |
| 21 | Operating belt |
| 22 | Supporting device |
| 23 | Drive unit |
| 24 | Driving unit |
| 25 | Cleaning device |
| 25a | Cleaning operating belt |
| 25b | Disinfection device |
| 25c | Vacuum cleaner |
| 26 | Storage frame |
| 27 | Guide rail |
| 30 | Coupling device |
| 31 | Intermediate wheel |
| 32 | Contact wheel |
| 33 | Connecting element |
| 40 | Treating unit, baking oven |
| 41 | Storage belt |
| 42 | Contact wheel |
| 43 | Connecting element |
| 50 | Dispensing unit |
| 51 | Storage belt |
| 60 | Filling unit |
| 61 | Storage belt |
| 62 | Display device |
| 63 | Filling area |
| 64 | Storage area |
| 65 | Projector |
| 70 | Storage unit |
| 71 | Storage belt |
| 80 | Cooling/deep-freeze storage unit |
| 81 | Storage belt |
| 90 | Reject receiving unit |
| 100 | Product, bakery product |
| 130 | Coupling device |
| 131 | Intermediate wheel |
| 132 | Contact wheel |
| 133 | Connecting element |
| R | Movement direction |
| RB | Operating direction |
| RS | Tilt direction |
| RV | Vertical direction |
| RH | Horizontal direction |
| RZ | Intermediate wheel direction |
| RK | Contact wheel direction |

1-10. (canceled)

11. A device for treating products in particular bakery products, comprising:
at least one treating unit, in particular, in the form of a baking oven comprising at least one storage belt and arranged to process the products;
at least one dispensing unit comprising at least one storage belt and arranged to dispense the finished products to a customer; and
at least one operating device adapted to transport the products between the units;
wherein the operating device comprises at least one operating belt and at least one coupling device;
wherein the operating belt is arranged to store the products;
wherein the coupling device is arranged to couple the operating belt to a storage belt in order to exchange the products with the coupled storage belt, and
wherein the coupling device comprises at least one drive unit which is arranged to drive at least one storage belt coupled to the operating device.

12. The device according to claim 11,
wherein the coupling device is arranged to couple the operating belt to the storage belt mechanically, preferably with the aid of an intermediate element, preferably an intermediate wheel, or contactlessly; and/or
wherein the coupling device comprises only one drive unit; and/or
wherein in the coupled state the belt of the operating belt and the belt of a coupled storage belt are without contact.

13. The device according to claim 11,
wherein the operating belt is formed in several parts, preferably in two parts.

14. The device according to claim 11,
wherein the operating device comprises a supporting device which is arranged to support the operating belt and to move it horizontally and/or vertically.

15. The device according to claim 14,
wherein the supporting device is arranged to tilt the operating belt against the horizontal; and/or
wherein the operating device comprises a storage frame on which the supporting device is mounted.

16. The device according to claim 11,
wherein the operating device comprises a cleaning device adapted to clean a coupled storage belt; and
wherein preferably the cleaning device comprises a vacuum cleaner and/or a disinfecting device.

17. The device according to claim 11,
wherein the operating device is designed as a driverless transport system, AGV; and/or
wherein preferably a movement of the operating device is determined by a rail system.

18. The device according to claim 11, comprising:
at least one storage unit comprising at least one storage belt and adapted to store the products; and/or
at least one filling unit comprising at least one storage belt and arranged to fill the device with products.

19. The device according to claim 11, comprising:
a control device which is arranged to control the operating device (20) in a self-learning manner.

20. A method of treating products, comprising the steps of:
processing of the products by a treating unit, in particular, in the form of a baking oven, comprising at least one storage belt;
coupling an operating belt of an operating device to the storage belt of the treating unit by a coupling device of the operating device;
exchanging products between the operating belt and the storage belt (41) coupled to the operating belt of the treating unit; and
transporting the products from the treating unit to a dispensing unit, which at least comprises a storage belt;
coupling the operating belt of the operating unit with the storage belt of the dispensing unit by the coupling device of the operating device;
dispensing the finished products by the dispensing unit to the customer.
